(19) United States
(12) Patent Application Publication
(10) Pub. No.: US 2014/0146445 A1
(43) Pub. Date: May 29, 2014

(54) PORTABLE INPUT DEVICE

(71) Applicant: CHICONY ELECTRONICS CO., LTD., New Taipei City (TW)

(72) Inventors: Chuan-Kung LAI, Taipei Hsien (TW); I-Heng CHEN, Taipei Hsien (TW)

(21) Appl. No.: 13/874,401

(22) Filed: Apr. 30, 2013

(30) Foreign Application Priority Data
Nov. 27, 2012 (TW) 101222964

(51) Int. Cl. G06F 3/02

(52) U.S. Cl. CPC G06F 3/0221
USPC 361/679.1; 361/679.09

(57) ABSTRACT

A portable input device includes a support board, a plurality of key modules, a second input module, a cover, and at least one control unit. The support board has a first disposing region and a second disposing region. The key modules are located on the first disposing region of the support board. The cover covers the support board and has at least one opening. An accommodating space is defined by the cover and the second disposing region of the support board. The second input module is located in the accommodating space. The control unit is located in the accommodating space and electrically connected to the key modules and the second input module.

### RELATED APPLICATIONS

This application claims priority to Taiwan Application Serial Number 101222964, filed Nov. 67, 2012, which is herein incorporated by reference.

### BACKGROUND

1. Technical Field

The present disclosure relates to a portable input device.

2. Description of Related Art

With the development of science and technology, the size and weight of electronic devices have decreased significantly. Moreover, input devices used in electronic devices, and in particular keyboards, also must be made to small sizes. In the case of a tablet computer, although a touch screen may be used as an input device therefor and a physical keyboard can be omitted, when a user needs to input a lot of words and other information, a virtual keyboard may be displayed on the touch screen. However, such a virtual keyboard occupies a large portion of the touch screen, and in addition, a virtual keyboard cannot provide the same tactile sensation as a physical keyboard, such that it is easy to press on a wrong key.

While a conventional capacitive keyboard may realize a small design, such a conventional capacitive keyboard cannot provide the same tactile sensation as a physical keyboard. Furthermore, when the user inadvertently contacts a surface of the capacitive keyboard, the keys of the capacitive keyboard may be activated. Therefore, the conventional capacitive keyboard has disadvantages that need to be overcome.

In addition, a conventional input device having physical keys and a touch pad includes a plurality of keys, a substrate, a touch pad module, a main printed circuit board, a top casing, and a bottom casing. The keys are located on the substrate. The touch pad module and the substrate overlap the main printed circuit board. The main printed circuit board is arranged on the bottom casing and is covered by the top and bottom casings. Since the conventional input device requires such a multi-layer structure in which the substrate, the main printed circuit board, and the top and bottom casings overlap, the thickness of the keyboard cannot be reduced, making it difficult to achieve the purpose of miniaturization.

### SUMMARY

An aspect of the present invention is to provide a portable input device. In an embodiment of the present invention, a portable input device includes a support board, a plurality of key modules, a cover, and at least one control unit. The support board has a first disposing region and a second disposing region. The key modules are located on the first disposing region of the support board. The cover covers the support board. The cover has at least one opening aligned with the key modules. An accommodating space is defined by the cover and the second disposing region of the support board. A second input module is located in the accommodating space. The control unit is located in the accommodating space and electrically connected to the key modules and the second input module.

In an embodiment of the present invention, the cover has another opening aligned with the second input module.

In an embodiment of the present invention, the size of the cover is substantially equal to the size of the support board.

In an embodiment of the present invention, the cover further includes a plurality of reinforcing protruding ribs located on an inner surface of the cover facing the support board.

In an embodiment of the present invention, the portable input device further includes an adhesive located on top surfaces of the reinforcing protruding ribs for adhering the cover to the support board.

In an embodiment of the present invention, the support board has a plurality of positioning through holes. The cover further includes a plurality of hot melt columns respectively received in the positioning through holes. When the hot melt columns are deformed by heat, the cover is fixed on the support board by the hot melt columns.

In an embodiment of the present invention, the positioning through holes are located in the first disposing region of the support board.

In an embodiment of the present invention, the portable input device further includes a decoration board located on a bottom surface of the support board.

In an embodiment of the present invention, the decoration board is made of a material that includes leather, glass fiber, plastic, or metal.

In an embodiment of the present invention, the portable input device further includes a flexible frame body. The flexible frame body surrounds the support board and covers an edge of the support board.

In an embodiment of the present invention, the flexible frame body is made of a material that includes cloth fiber or leather.

In an embodiment of the present invention, the support board has a plurality of connection members. Each of the key modules includes a key cap and a scissor structure. The scissor structure is connected between the key cap and the corresponding connection member, such that the key cap is located on the support board in a vertically reciprocatable manner.

In an embodiment of the present invention, each of the key modules further includes a elastic element located under the key cap. The portable input device further includes a membrane circuit board. The membrane circuit board is located on the first disposing region of the support board and electrically connected to the control unit. The elastic element is located between the membrane circuit board and the corresponding key cap.

In an embodiment of the present invention, the portable input device further includes a battery module located in the accommodating space for providing power to the control unit.

In an embodiment of the present invention, the portable input device further includes d wireless communication module. The wireless communication module is located in the accommodating space and electrically connected to the control unit.

In an embodiment of the present invention, the wireless communication module includes a Bluetooth® module.

In an embodiment of the present invention, the wireless communication module includes a near field communication (NFC) module.

In an embodiment of the present invention, each of the support board and the cover is integrally formed as a single piece.

In an embodiment of the present invention, the support board is made of a material that includes metal, glass fiber, or plastic.

In an embodiment of the present invention, the second input module is a touch pad module.

In an embodiment of the present invention, the second input module is fixed on an inner surface of the cover.

In an embodiment of the present invention, the second input module is fixed on the second disposing region of the support board.

In an embodiment of the present invention, a first groove is surroundingly formed on an edge of an inner surface of the cover facing the support board. The portable input device further includes an adhesive located in the first groove for adhering the cover to the support board.

In an embodiment of the present invention, a second groove is surroundingly formed on a position of an inner surface of the cover adjacent to an edge of the first disposing region of the support board. The portable input device further includes an adhesive located in the second groove for adhering the cover to the support board.

In the aforementioned embodiments of the present invention, since the key modules are disposed in the first disposing region of the support board, the second input module is arranged in the accommodating space defined by the cover and the support board, and the cover has the opening aligned with the key modules, when the cover covers the support board, the key modules are exposed through the opening of the cover. Since the portable input device has the key modules and the second input module, the portable input device not only has a key input function, but also has an additional input function, such as a touch pad input function. In addition, electronic elements can be contained in the accommodating space defined by the cover and the second disposing region of the support board.

Each of the cover and the support board of the portable input device is integrally formed as a single piece, and the reinforcing protruding ribs can improve the strength of the cover. Therefore, the portable input device can have a high degree of strength, such that a bottom casing of a conventional physical keyboard and a large printed circuit board can be omitted from the configuration of the portable input device, thereby allowing miniaturization of the portable input device. Moreover, the portable input device can be manufactured to the same size as a tablet computer. When a user carries a tablet computer, the portable input device can be placed overlapping the tablet computer, so as to allow for carrying convenience.

### BRIEF DESCRIPTION OF THE DRAWINGS

FIG. 1 is a perspective view of a portable input device according to an embodiment of the present invention;

FIG. 2 is a partial exploded view of the portable input device shown in FIG. 1;

FIG. 3 is a perspective view of the portable input device shown in FIG. 1 when a cover is removed;

FIG. 4 is an exploded view of a key module shown in FIG. 1;

FIG. 5 is a perspective view of the cover shown in FIG. 2 after being flipped over;

FIG. 6 is a partial enlarged view of the cover shown in FIG. 5;

FIG. 7 is a top view of the cover shown in FIG. 5 after an adhesive is applied thereto;

FIG. 8 is a rear perspective view of the portable input device shown in FIG. 1 after a decoration board is removed; and

FIG. 9 is a top view of a cover according to an embodiment of the present invention after an adhesive is applied thereto.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

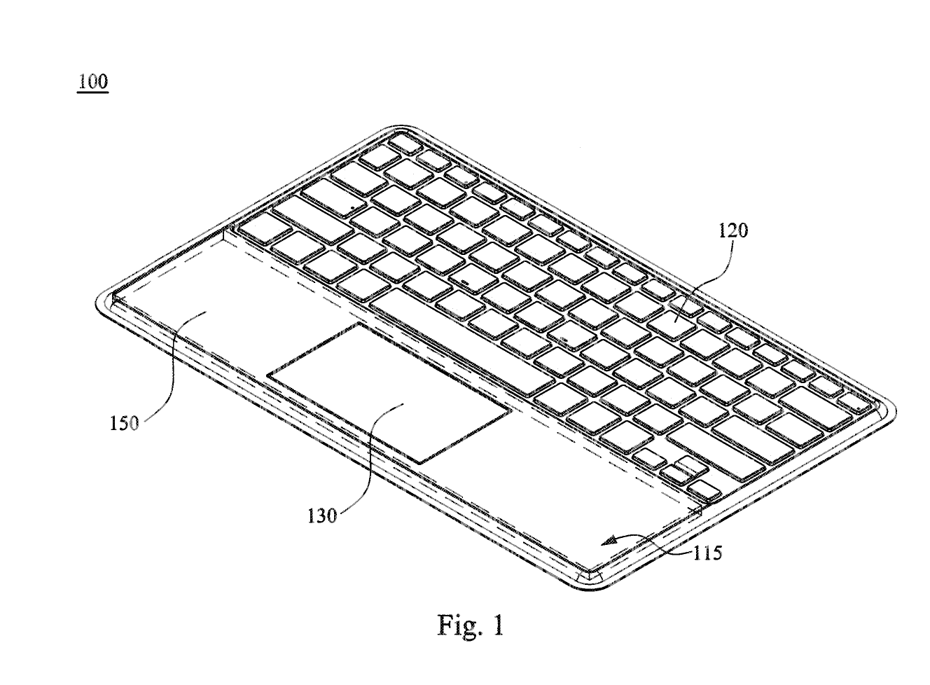

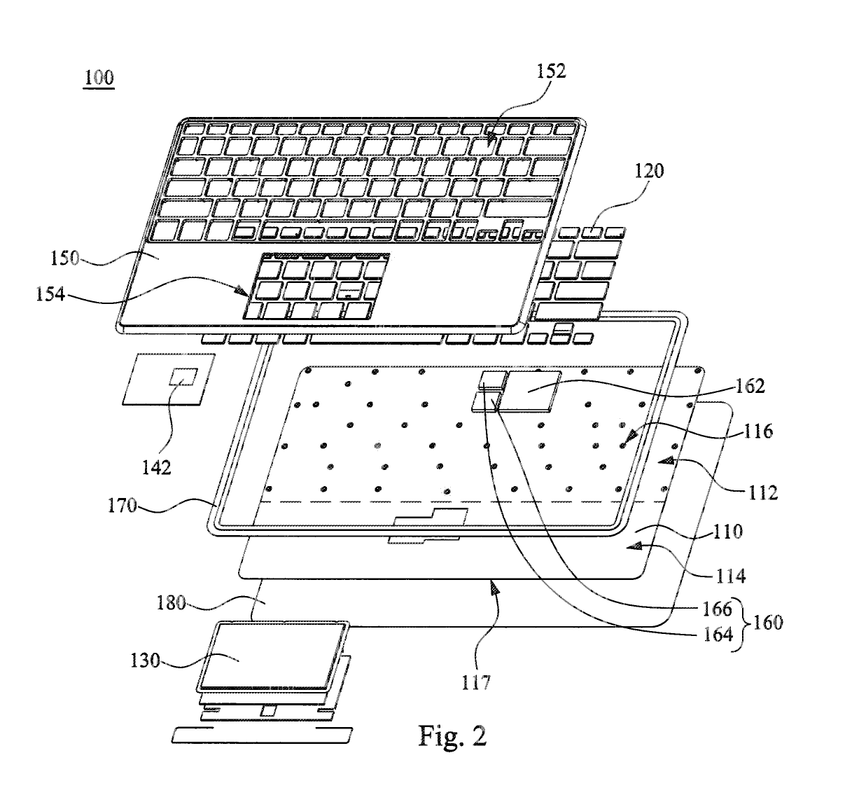

FIG. 1 is a perspective view of a portable input device 100 according to an embodiment of the present invention. FIG. 2 is a partial exploded view of the portable input device 100 shown in FIG. 1. As shown as FIG. 1 and FIG. 2, the portable input device 100 includes a support board 110, a plurality of key modules 120 (which may be regarded as a first input module), a second input module 130, a cover 150, and a control unit 142. A top surface of the support board 110 can be divided into a first disposing region 112 and a second disposing region 114, and the key modules 120 are located on the first disposing region 112. In this embodiment, the first disposing region 112 shown in FIG. 2 is on an upper side region of a dotted line, and the second disposing region 114 shown in FIG. 2 is on a lower side region of the dotted line. However, the positions and shapes of the first and second disposing regions 112, 114 may be varied as needed by the designer, and the present invention is not limited in this regard.

The cover 150 covers the support board 110, and an accommodating space 115 is defined by the cover 150 and the second disposing region 114 of the support board 110. The second input module 130 is disposed in the accommodating space 115. In this embodiment, the cover 150 has openings 152, 154 respectively corresponding to the key modules 120 and the second input module 130. That is to say, the positions of the openings 152 are respectively aligned with the positions of the key modules 120, and the position of the opening 154 is aligned with the position of the second input module 130, such that the key modules 120 and the second input module 130 can be respectively exposed through the openings 152, 154. In this embodiment, the second input module 130 is a touch pad module, but the second input module 130 may be based on a different input configuration depending on product requirements.

In addition, other electronic elements can be contained in the accommodating space 115 defined by the cover 150 and the second disposing region 114 of the support board 110. For example, the control unit 142 is located in the accommodating space 115 and electrically connected to the key modules 120 and the second input module 130, such that the control unit 142 can transfer signals from the key modules 120 and the second input module 110 to an electronic device (e.g., a tablet computer). The present invention is not limited in the number of the control units 142. For instance, the key modules 120 and the second input module 130 also can be respectively electrically connected to two different control units 142.

In this embodiment, the size of the cover 150 is substantially equal to the size of the support board 110. “Substantially equal” may encompass a size difference of 10% or less, but the present invention is not limited in this regard. Furthermore, each of the support board 110 and the cover 150 may be integrally formed as a single piece. The support board 110 may be made of a material that includes metal, glass fiber, or plastic, and the material of the cover 150 may include plastic, but the present invention is not limited in this regard. Since the cover 150 and the support board 110 are integrally formed structures and are assembled to each other, the structural strength of the portable input device 100 can be improved. As a result, the portable input device 100 is rugged enough so that permanent deformation does not occur when bent.

The portable input device 100 may further include a flexible frame body 170 and a decoration board 180. The flexible frame body 170 surrounds the support board 110 and covers an edge of the support board 110. The decoration board 180 is located on a bottom surface 117 of the support board 110, such that the support board 110 is located between the decoration board 180 and the cover 150. The flexible frame body 170 may be made of a material that includes cloth fiber or leather, and the decoration board 180 may be made of a material that includes leather, glass fiber, plastic, or metal, but the materials of the flexible frame body 170 and the decoration board 180 are not limited by the aforementioned materials. During assembly of the flexible frame body 170 and the decoration board 180, a surface of the flexible frame body 170 may be adhered to the cover 150 and the decoration board 180, such that an edge of the support board 110 is not exposed between the cover 150 and the decoration board 180. As a result, the aesthetics of the portable input device 100 is significantly improved, and this stricture can prevent the decoration board 180 from being detached by users.

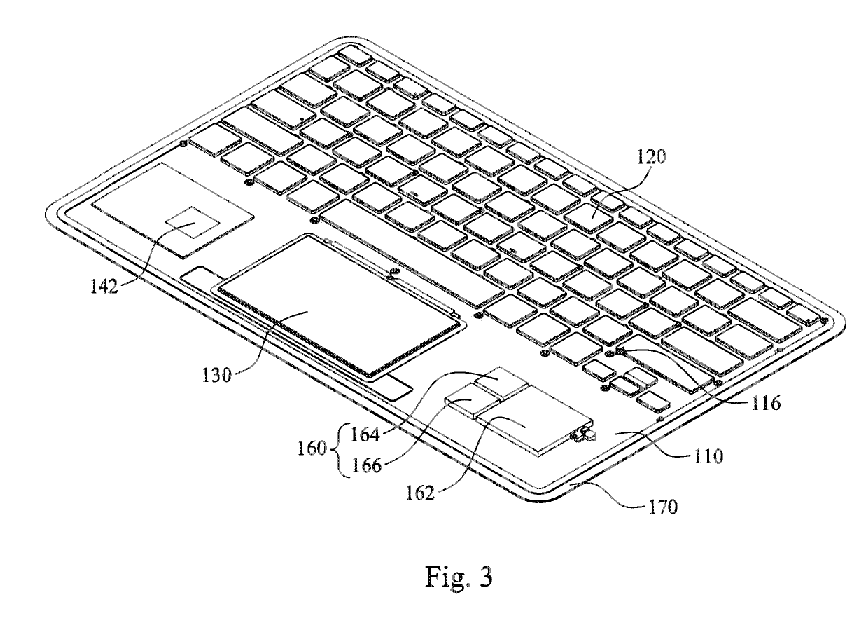

FIG. 3 is a perspective view of the portable input device 100 shown in FIG. 1 when the cover 150 is removed. As shown in FIG. 2 and FIG. 3, the portable input device 100 may further include other electronic elements, such as a battery module 162 and a wireless communication module 160. In this embodiment, the wireless communication module 160 includes a Bluetooth® module 164 and a near field communication (NFC) module 166. The aforementioned electronic elements (e.g., the battery module 162 and the wireless communication module 160) may be located in the accommodating space 115 defined by the cover 150 and the second disposing region 114 of the support board 110. The battery module 162 can provide power to the control unit 142. The wireless communication module 160 can be electrically connected to the control unit 142. In use, the control unit 142 can receive signals from an electronic device (e.g., a tablet computer) to switch on or off the Bluetooth® module 164 and the NFC module 166 of the wireless communication module 160.

In this embodiment, the second input module 130 is arranged in the accommodating space 115 defined by the cover 150 and the second disposing region 114 of the support board 110. Moreover, the second input module 130 may be fixed on an inner surface of the cover 150 shown in FIG. 2 (i.e., a surface facing the support board 110), or may be fixed on the second disposing region 114 of the support board 110. As long as the second input module 10 can be exposed through the opening 154 and operated by users, the present invention is not limited in this regard. If the second input module 130 is not operated by being touched, such as in the case where the second input module 130 is a capacitive touch module, the opening 154 aligned with the second input module 130 does not need to be formed in the cover 150, and users can operate the second input module 130 by contacting the cover 150.

Since the key modules 120 are disposed in the first disposing region 112 of the support board 110, the second input module 130 is arranged in the accommodating space 115 defined by the cover 150 and the support board 110, and the cover 150 has the openings 152, 154 respectively aligned with the key modules 120 and the second input module 130, when the cover 150 covers the support board 110, the key modules 120 and the second input module 130 can be exposed through the openings 152, 154. Since the portable input device 100 has the key modules 120 and the second input module 130, the portable input device 100 not only has a key input function, but also has an additional input function, such as a touch input function through a touch pad module.

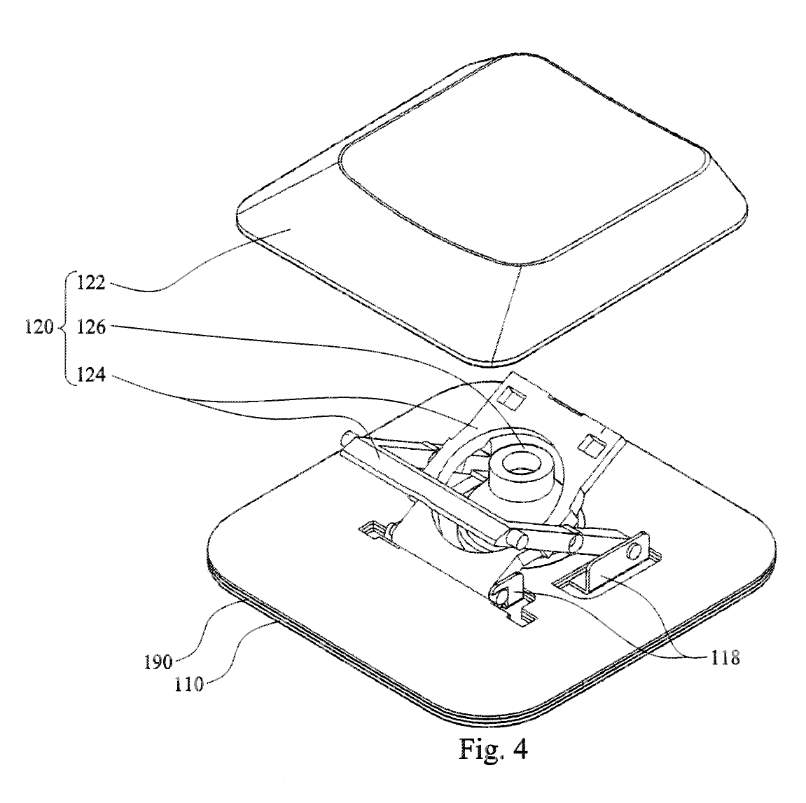

FIG. 4 is an exploded view of one of the key modules 120 shown in FIG. 1. As shown in FIG. 2 and FIG. 4, the support board 110 has a plurality of connection members 118. Each of the key modules 120 includes a key, cap 122, a scissor structure 124, and a elastic element 125. The key cap 122 is exposed through one of the openings 152 of the cover 150. The scissor structure 124 is connected between the key cap 122 and the connection member 118, such that the key cap 122 is located on the support board 110 in a vertically reciprocatable manner. Moreover, the support board 110 may further include a membrane circuit board 190. The membrane circuit board 190 is located on the first disposing region 112 of the support board 110 and electrically connected to the control unit 142. The elastic element 126 is located under the key cap 122 and between the membrane circuit board 190 and the key cap 122. The elastic element 126 can provide a recovery force to the key cap 122. When the key cap 122 is pressed, the elastic element 126 can contact the membrane circuit board 190, and the key module 120 sends a pressing signal to the control unit 142.

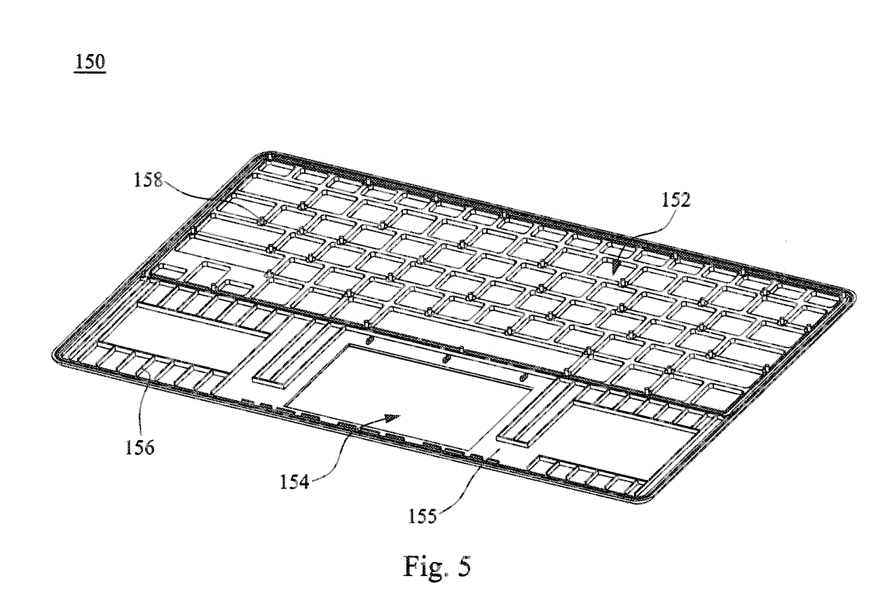

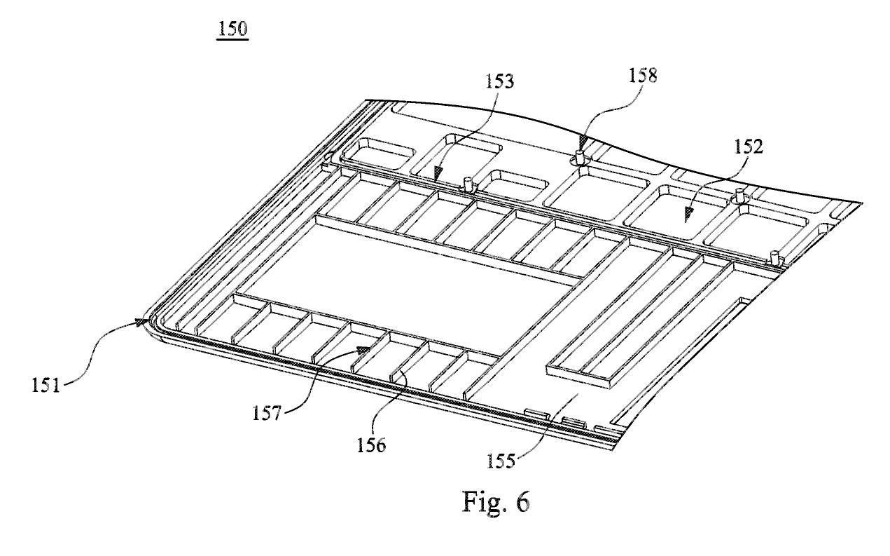

FIG. 5 is a perspective view of the cover 150 shown in FIG. 2 after being flipped over. FIG. 6 is a partial enlarged view of the cover 150 shown in FIG. 5. As shown in FIG. 5 and FIG. 6, the cover 150 may further include a plurality of reinforcing protruding ribs 156. The reinforcing protruding ribs 156 are located on an inner surface 155 of the cover 150 (i.e., a surface facing the support board 110 shown in FIG. 2). The reinforcing protruding ribs 156 are integrally formed on the inner surface 155 of the cover 150.

As shown in FIG. 1 and FIG. 5, each of the cover 150 and the support board 110 (see FIG. 2) of the portable input device 100 is integrally formed as a single piece, and the reinforcing protruding ribs 156 of the cover 150 can improve the strength of the cover 150. Therefore, the portable input device 100 can have a high degree of strength, such that a bottom casing of a conventional physical keyboard and a large main printed circuit board can be omitted from the configuration of the portable input device 110, thereby allowing miniaturization of the portable input device. Moreover, the portable input device 100 can be manufactured to the same size as a tablet computer. When a user carries a tablet computer, the portable input device 100 can be placed overlapping the tablet computer, so as to allow for carrying convenience. For example, a tablet computer and the portable input device 100 placed overlapping therewith can be both placed in a protection jacket of the tablet computer.

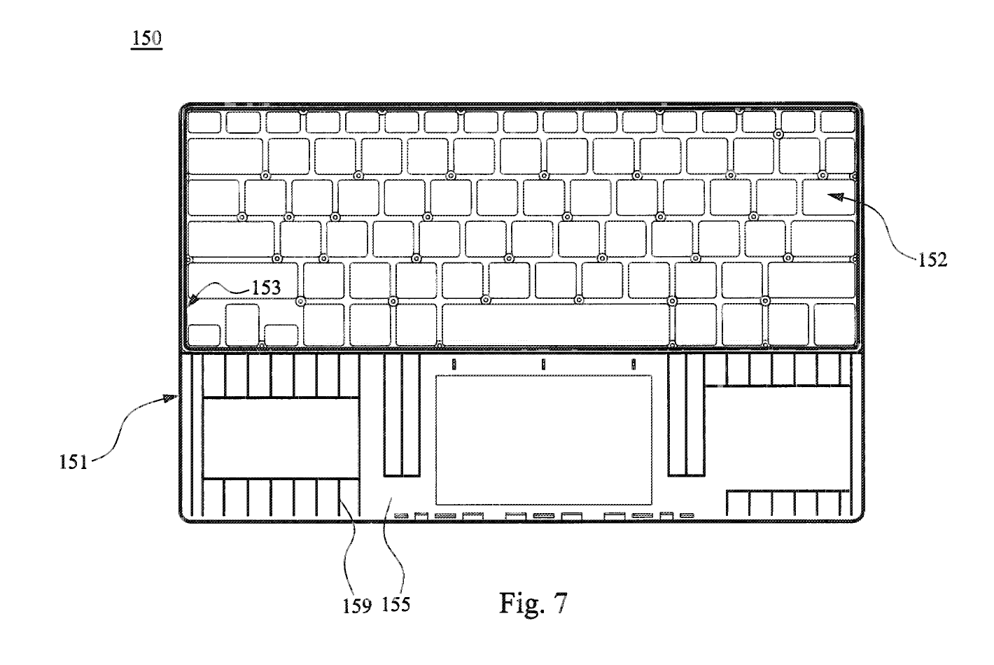

FIG. 7 is a top view of the cover 150 shown in FIG. 5 after an adhesive 159 is applied thereto. As shown in FIG. 6 and FIG. 7, a first groove 151 is surroundingly formed on an edge of the inner surface 155 of the cover 150 facing the support board 110 (see FIG. 2), and a second groove 153 is surroundingly formed on a position of the inner surface 155 of the cover 150 adjacent to an edge of the first disposing region 112 (see FIG. 2) of the support board 110.

In this embodiment, the adhesive 159 (indicated by bold lines in FIG. 7) is located on top surfaces 157 of the reinforcing protruding ribs 156 of the cover 150 and in the first and second grooves 151, 153 of the cover 150. When assembling the cover 150 and the support board 110 (see FIG. 2), the adhesive 159 adheres the cover 150 to the support board 110.

Furthermore, the cover 150 may further include a plurality of hot melt columns 158. In the following description, assembly of the hot melt columns 158 and the support board 110 (see FIG. 2) will be described.

As shown in FIG. 2 and FIG. 5, the support board 110 has a plurality of positioning through holes 116. The positioning through holes 116 are located in the first disposing region 112 of the support board 110. When assembling the cover 150 and the support board 110, the hot melt columns 158 of the cover 150 can be respectively received in the positioning through holes 116.

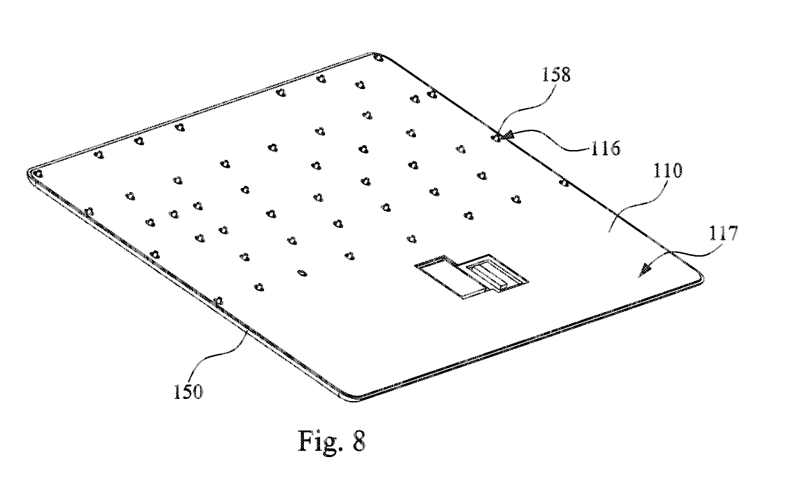

FIG. 8 is a rear perspective view of the portable input device 100 shown in FIG. 1 after the decoration board 180 is removed. When the hot melt columns 158 of the cover 150 are respectively received in the positioning through holes 116 of the support board 110, the hot melt columns 158 can be heated, such that the hot melt columns 158 are deformed by the heat. After the deformed hot melt columns 158 are molded by cooling, the cover 150 can be fixed on the support board 110 by the hot melt columns 158.

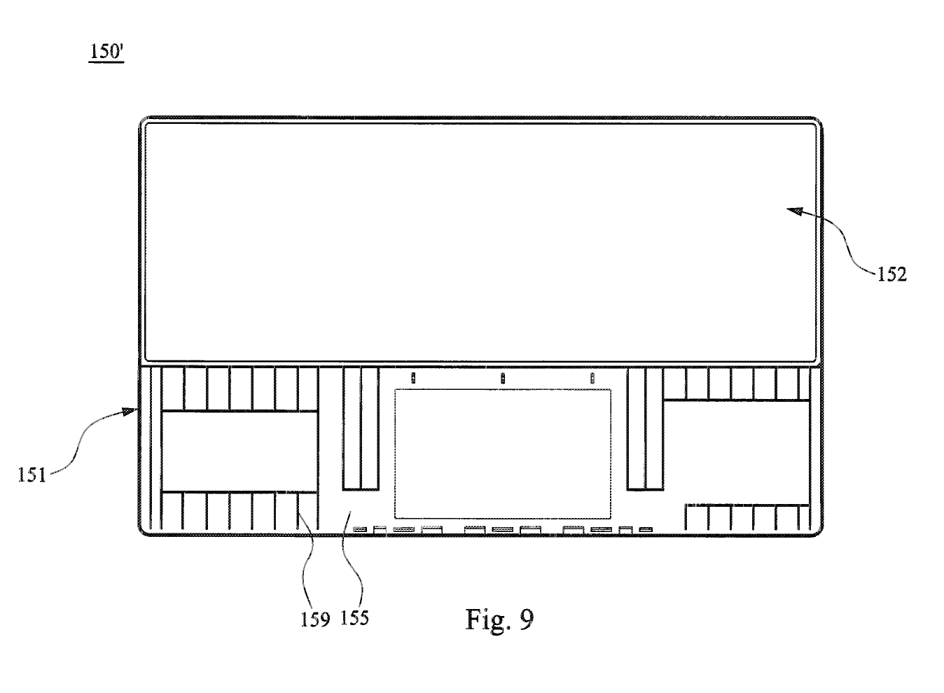

FIG. 9 is a top view of a cover 150′ according to an embodiment of the present invention after an adhesive 159 is applied thereto. The differences between this embodiment and the embodiment shown in FIG. 7 are that the cover 150′ only has a single opening 152 aligned with the key modules 120 (see FIG. 2), and the inner surface 155 of the cover 150′ only has the first groove 151 and does not have the second groove 153 shown in FIG. 6. In this embodiment, the adhesive 159 is indicated by bold lines in FIG. 3. When assembling the cover 150′ and the support board 110 (see FIG. 2), the adhesive 159 adheres the cover 150′ to the support board 110.

Compared with a conventional keyboard, the portable input device of the present invention has the key modules and the second input module (e.g., a touch pad module). Therefore, the portable input device not only has a key input function, but also has an additional input function. Electronic elements, such as the control unit, a battery module, a Bluetooth® module, an NFC module, a printed circuit board, etc., can be contained in the accommodating space defined by the cover and the second disposing region of the support board. Each of the support board and the cover of the portable input device is integrally formed as a single piece, and the reinforcing protruding ribs of the cover can improve the strength of the cover. Therefore, the portable input device can have a high degree of strength, such that a bottom casing of a conventional physical keyboard and a large main printed circuit board can be omitted from the configuration of the portable input device, thereby allowing miniaturization of the portable input device. Moreover, the portable input device can be manufactured to the same size as a tablet computer. When a user carries a tablet computer, the portable input device can be placed overlapping the tablet computer, so as to allow for carrying convenience.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A portable input device comprising:
a support board having a first disposing region and a second disposing region;
a plurality of key modules disposed on the first disposing region of the support board;
a cover covering the support board, wherein the cover has at least one opening aligned with the key modules, an accommodating space is defined by the cover and the second disposing region of the support board, and a second input module is disposed in the accommodating space; and
at least one control unit disposed in the accommodating space and electrically connected to the key modules and the second input module.

2. The portable input device as claimed in claim 1, wherein the cover has another opening aligned with the second input module.

3. The portable input device as claimed in claim 1, wherein the size of the cover is substantially equal to the size of the support board.

4. The portable input device as claimed in claim 1, wherein the cover further comprises:
a plurality of reinforcing protruding ribs located on an inner surface of the cover facing the support board.

5. The portable input device as claimed in claim 4, further comprising:
an adhesive located on top surfaces of the reinforcing protruding ribs for adhering the cover to the support board.

6. The portable input device as claimed in claim 1, wherein the support board has a plurality of positioning through holes, and the cover further comprises:
a plurality of hot melt columns respectively received in the positioning through holes, wherein when the hot melt columns are deformed by heat, the cover is fixed on the support board by the hot melt columns.

7. The portable input device as claimed in claim 6, wherein the positioning through holes are located in the first disposing region of the support board.

8. The portable input device as claimed in claim 1, further comprising:
a decoration board disposed on a bottom surface of the support board.

9. The portable input device a claimed in claim wherein the decoration board is made of a material that includes leather, glass fiber, plastic, or metal.

10. The portable input device as claimed in claim 8, further comprising:
a flexible frame body surrounding the support board and covering an edge of the support board.

11. The portable input device as claimed in claim 10, wherein the flexible frame body is made of a material that includes cloth fiber or leather.

12. The portable input device as claimed in claim 1, wherein the support board has a plurality of connection members, and each of the key modules comprises:
a key cap; and
a scissor structure connected between the key cap and the corresponding connection member, such that the key cap is disposed on the support board in a vertically reciprocatable manner.

13. The portable input device as claimed in claim 12, wherein each of the key modules further comprises a elastic element disposed under the key cap, and the portable input device further comprises:
a membrane circuit board located on the first disposing region of the support board and electrically connected to the control unit, wherein the elastic element is located between the membrane circuit board and the corresponding key cap.

14. The portable input device as claimed in claim 1, further comprising:
a battery module disposed in the accommodating space for providing power to the control unit.

15. The portable input device as claimed in claim 1, further comprising:
a wireless communication module disposed in the accommodating space and electrically connected to the control unit.

16. The portable input device as claimed in claim 15, wherein the wireless communication module comprises a Bluetooth® module.

17. The portable input device as claimed in claim 15, wherein the wireless communication module comprises a near field communication (NFC) module.

18. The portable input device as claimed in claim 1, wherein each of the support board and the cover is integrally formed as a single piece.

19. The portable input device as claimed in claim 1, wherein the support board is made of a material that includes metal, glass fiber, or plastic.

20. The portable input device as claimed in claim 1, wherein the second input module is a touch pad module.

21. The portable input device as claimed in claim 1, wherein the second input module is fixed on an inner surface of the cover.

22. The portable input device as claimed in claim 1, wherein the second input module is fixed on the second disposing region of the support board.

23. The portable input device as claimed in claim 1, wherein a first groove is surroundingly formed on an edge of an inner surface of the cover facing the support board, and the portable input device further comprises:
an adhesive located in the first groove for adhering the cover to the support board.

24. The portable input device as claimed in claim 1, wherein a second groove is surroundingly formed on a position of an inner surface of the cover adjacent to an edge of the first disposing region of the support board, and the portable input device further comprises:
an adhesive located in the second groove for adhering the cover to the support board.
